(19) United States
(12) Patent Application Publication
(10) Pub. No.: US 2025/0374844 A1
(43) Pub. Date: Dec. 11, 2025

(54) TILLING IMPLEMENT

(71) Applicants: Robert L. Bowlus, Osgood, IN (US); Terry J. Stutler, Versailles, IN (US)

(72) Inventors: Robert L. Bowlus, Osgood, IN (US); Terry J. Stutler, Versailles, IN (US)

(21) Appl. No.: 19/228,897

(22) Filed: Jun. 5, 2025

Related U.S. Application Data
(60) Provisional application No. 63/656,264, filed on Jun. 5, 2024.

(51) Int. Cl. A01B 35/08

(52) U.S. Cl. CPC A01B 35/08

(57) ABSTRACT

An off-road tilling implement for use with an off-road vehicle that includes a base plate with a rounded leading edge, blades extending at least 4 inches away from the plate on one side of the plate, each blade including a cutting edge that is at least 4 inches long, a wheel assembly on the opposite side, and a hitch assembly on the same side as the wheel assembly that includes a bidirectional hitch adapted to be coupled to the vehicle with either the blade side or the wheel side oriented upwardly, where the tilling implement can be towed behind the vehicle with either the blades extending into the earth to plow the earth or the wheels riding on the earth for towing.

### CROSS-REFERENCE TO RELATED APPLICATIONS

This application claims the benefit of U.S. Provisional Application No. 63/656,264, filed Jun. 5, 2024, which is hereby incorporated by reference.

### BACKGROUND

This disclosure relates to the field of tilling implements.

There is a need for tilling implement that can be used to plant remote plots that are only accessible with off-road vehicles. Food plots are a planted area set aside to act as a supplementary food source for wildlife. A food plot can be prepared to attract a game species to an area for hunting or can be used as part of habitat management. Food plots can increase the wildlife carry capacity of an ecosystem, increased opportunities for hunting and/or viewing wildlife. Common types of animals food plots are planted for include Bear, Moose, Rabbit, Woodchuck, Deer, Wild turkey, Grouse, and songbirds. In 2001 the United States Fish and Wildlife Service announced that 8.7 million people across the country maintained some sort of planting for the sole benefit of wildlife.

### BRIEF DESCRIPTION OF THE DRAWINGS

FIG. 1 is a top perspective view of a plot implement.

FIG. 2 is a bottom perspective view of the FIG. 1 plot implement.

FIG. 3 is a left elevational view of the FIG. 1 plot implement.

FIG. 4 is a bottom plan view of the FIG. 1 plot implement.

FIG. 5 is a front elevational view of the FIG. 1 plot implement.

FIG. 6 is a rear elevational view of the FIG. 1 plot implement.

FIG. 7 is a top perspective view of an plate assembly; a component of the FIG. 1 plot implement.

FIG. 8 is a top plan view of the FIG. 7 plate assembly.

FIG. 9 is a cross sectional view of the FIG. 7 plate assembly taken along line 9-9 in FIG. 8.

FIG. 10 is a top perspective view of a base plate, a component of the FIG. 7 plate assembly

FIG. 11 is a top perspective view of a blade; a component of the FIG. 7 plate assembly.

FIG. 12 is a side elevational view of the FIG. 11 blade.

FIG. 13 is a left elevational view of the FIG. 1 plot implement being towed behind a vehicle in a towing orientation.

FIG. 14 is a left elevational view of the FIG. 1 plot implement being towed behind a vehicle in a tilling orientation.

### DETAILED DESCRIPTION OF THE DRAWINGS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. Embodiments of the claimed invention are shown in detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

Disclosed is a tilling implement adapted for access to remote plots requiring off-road travel to arrive at the remote plot. Common uses for such a tilling implement include, but are not limited to, preparation of food plots and revegetation of disturbed land. A food plot is a planted area set aside to act as a supplementary food source for wildlife. A food plot can be prepared to attract a game species to an area for hunting or can be used as part of habitat management.

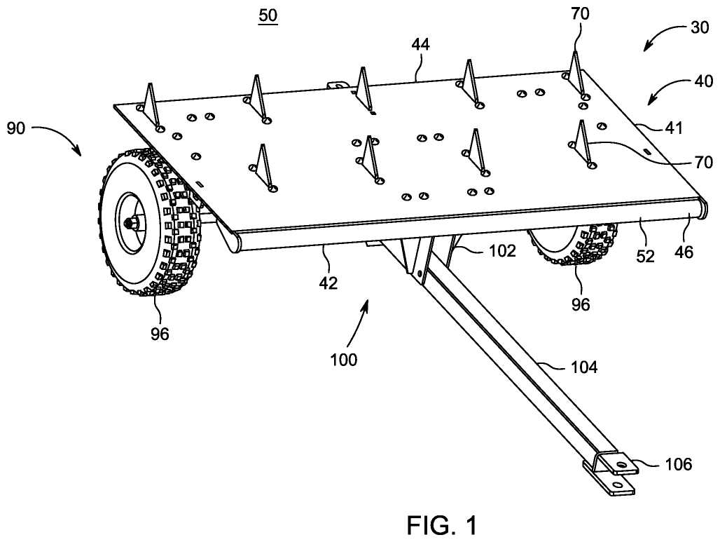

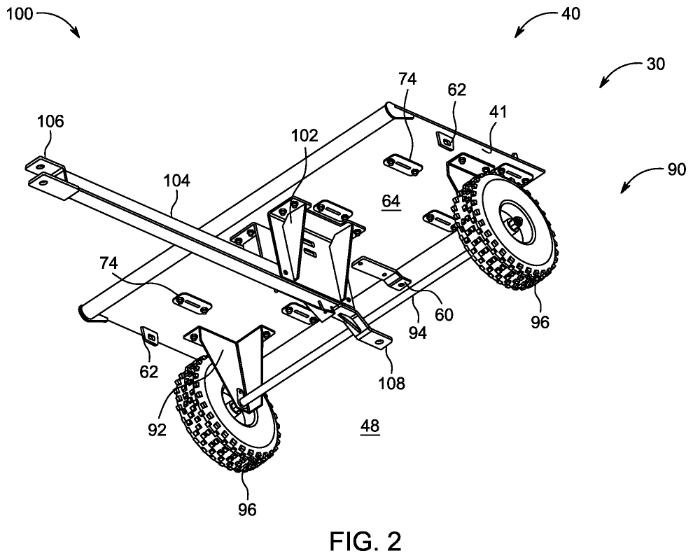

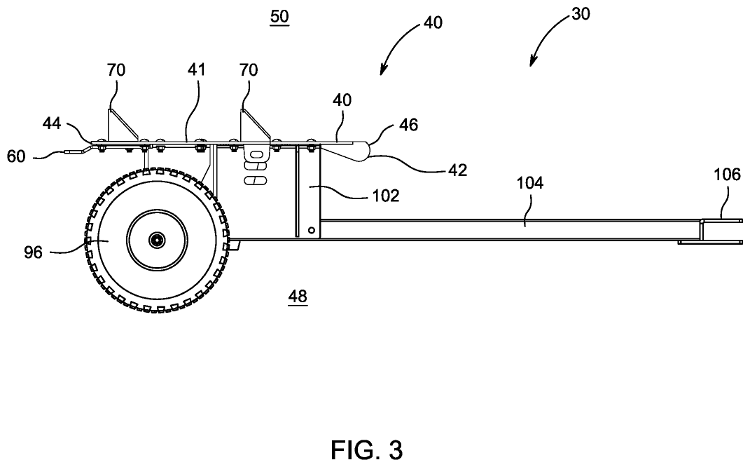

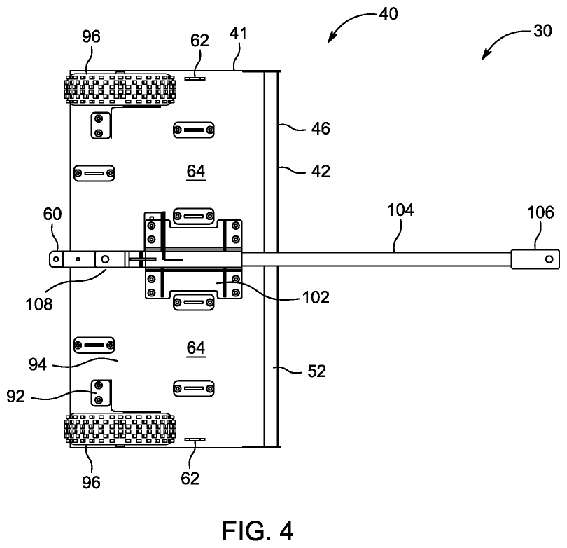

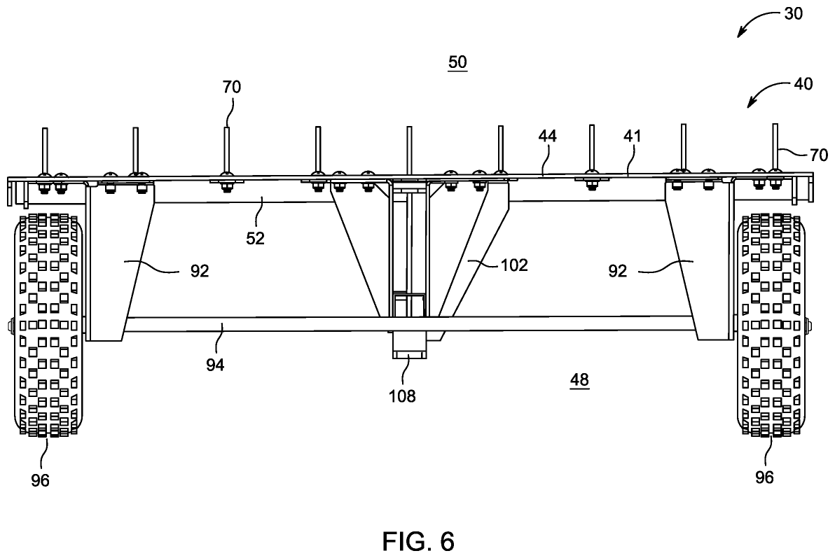

Referring to FIGS. 1-6, tilling implement 30 is illustrated. Tilling implement 30 generally includes plate assembly 40, wheel assembly 90 and hitch assembly 100. Tilling implement 30 defines a side 48 and a side 50 with blades 70 extending away from plate assembly 40 on side 50 and wheel assembly 90 extending away from plate assembly 40 on side 48.

Plate assembly 40 generally includes base plate 41, pipe 52, accessory mount 60, tie downs 62, and blades 70. Plate assembly 40 defines leading edge 42 and trailing edge 44. Pipe 52 is affixed to plate 41 along leading edge 42 and defines rounded edge 46 along leading edge 42. Base plate 41 defines a plurality of slots 54 through which blades 70 extend.

Wheel assembly 90 generally includes bracket 92, axle 94 and wheels 96. Bracket 92 couples axle 94 to plate assembly 40. Wheels 96 are positioned on opposite ends of axle 94.

Hitch assembly 100 generally includes bracket 102, tongue 104, hitch 106 and accessory mount 108. Bracket 102 couples tongue 104 to plate assembly 40. Hitch 106 and accessory mount 108 are positioned on opposite ends of tongue 104. Hitch 106 is a bidirectional hitch configured to couple to a vehicle hitch (not illustrated) in two orientations, one orientation with wheels 96 oriented upwardly and blades 70 extending into the ground and the other orientation with blades 70 oriented upwardly and wheels 96 riding on the ground. Thus, tilling implement can be towed behind a vehicle in a travel configuration with wheels riding on the ground and a tilling configuration with blades 70 extending into the earth to plow the earth.

Tilling implement 30 defines open regions 64 on either side of hitch assembly 100. Open regions 64 are positioned between hitch assembly 100 and tie downs 62. Each open region 64 defines an area at least 1 foot square that is sufficiently open to support a weighted object weighing at least 25 pounds. The weighted object can be secured relative to plate assembly 40 using a strap (not illustrated) or the like connected to tie downs 62 and/or bracket 102. A weighted object includes, but is not limited to, a bag of sand, seed or fertilizer, a rock and a bucket of debris.

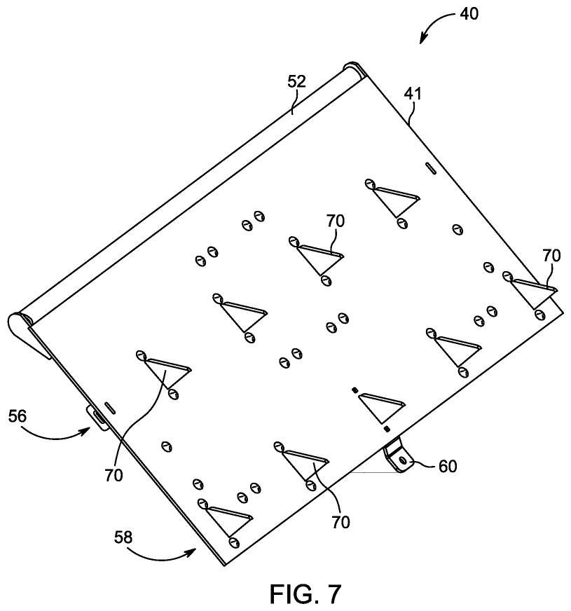

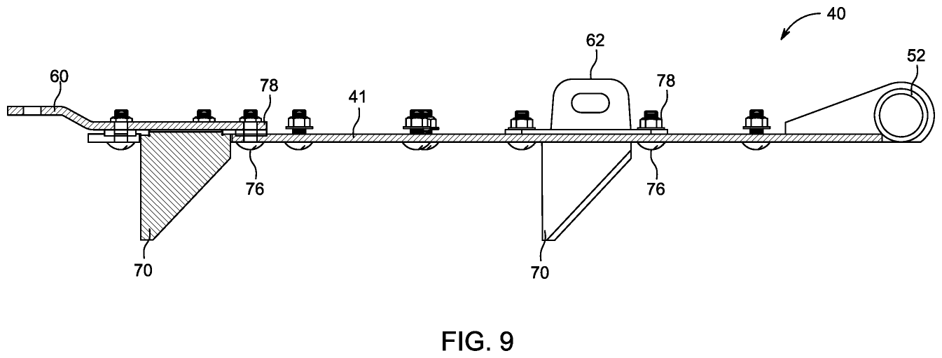

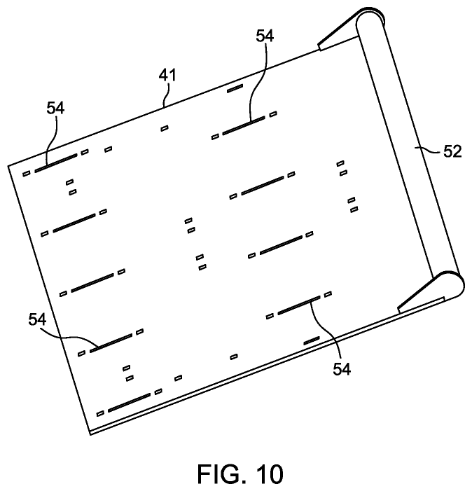

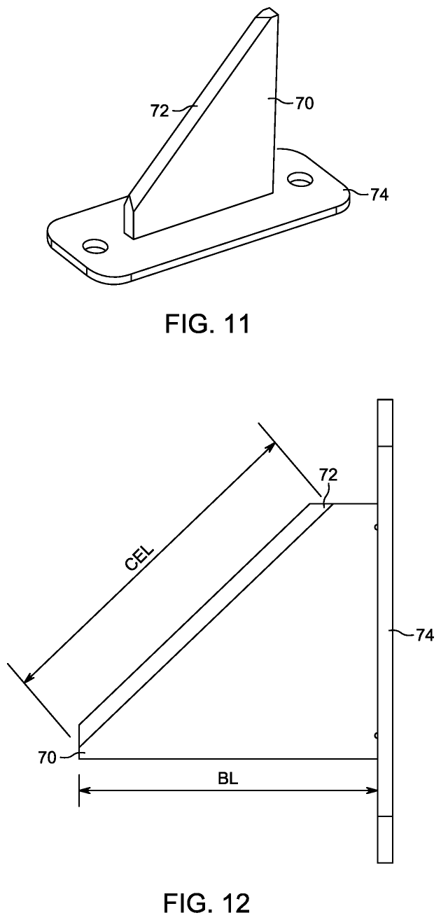

Referring to FIGS. 7-9, plate assembly 40 is illustrated. Referring to FIG. 10, base plate 41 is illustrated. Referring to FIGS. 11-12, blade 70 is illustrated. Blade 70 generally includes edge 72 and mounting plate 74. Blade 70 extends a blade length BL away from mounting plate 74. Edge 72 has a cutting edge length CEL. Blade length BL is at least 4 inches. Cutting edge length CEL is at least 4 inches.

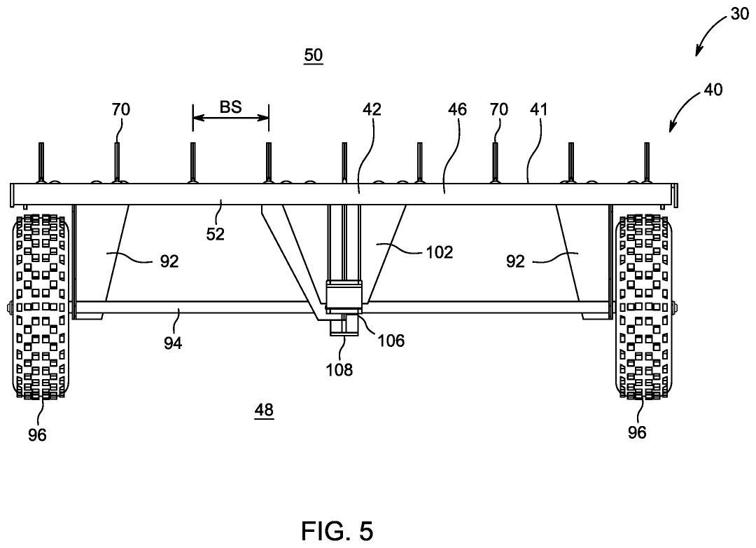

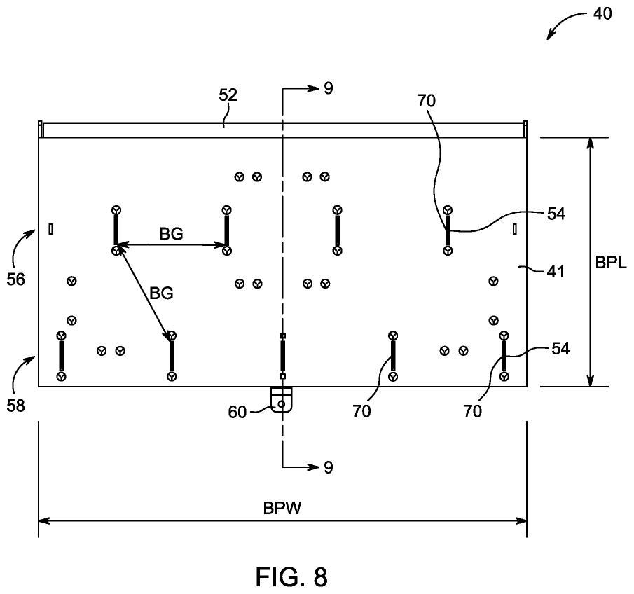

Base plate 41 may be constructed from sheet steel. In the illustrated embodiment, base plate 41 is a 2 foot by 4 foot section of half inch thick sheet steel. pipe 52 is welded on leading edge 42 defining rounded edge 46. As best shown in FIG. 8, in the illustrated embodiment, slots 54 are arranged in two offset rows 56 and 58 that span the width of base plate 41. As shown in FIG. 5, in the illustrated embodiment, slots 54 are arranged alternating between rows 56 and 58 with equal blade spacing between blades when viewed from the front. Slots are arranged to provide blade spacing BS. In the illustrated embodiment, blade spacing BS is at least 4 inches. Optionally, blade spacing BS does not exceed 7 inches. As shown in FIG. 8, individual slots are spaced apart blade gap BG. In the illustrated embodiment, blade gap BG is at least 8 inches.

Blades 70 are removably attached to base plate 41. Blades 70 individually extend through slots 54 with mounting plate 74 positioned on side 48 and blade 70 extending away from base plate 41 on side 50. Each blade 70 is coupled to base plate 41 with at least 2 fasteners. In the illustrated embodiment, each fastener is a nut and bolt, with the bolt head positioned on side 50 and the nut on side 48. This arrangement permits the replacement of damaged blades while minimizing protrusions on side 50. Alternatively, mounting plate 74 could include threaded holes and bolts which could thread directly into mounting plate 74. In yet other embodiments, rivets could be used instead of nuts and bolts.

Accessory mounts 60 and 108 can be used to attach additional equipment to tilling implement including a seed spreader and/or a fertilizer and/or a rake to cover spread seeds. Such accessories can be towed behind tilling implement 30 or can be removably attached on top of tilling implement 30 on side 48.

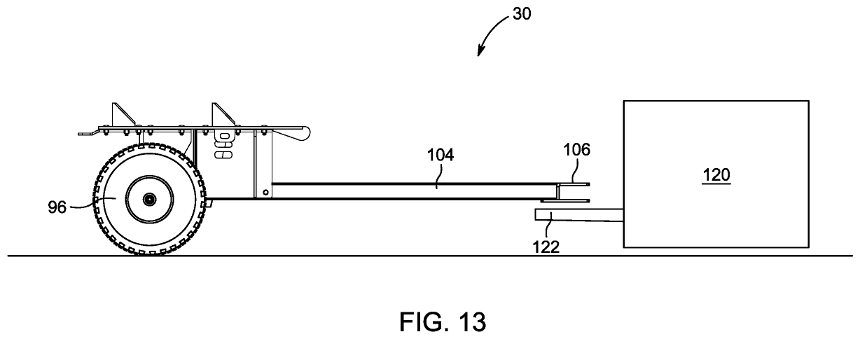

Referring to FIG. 13, tiling implement 30 is shown being towed behind vehicle 120 in a towing configuration. Vehicle 120 includes hitch 122 that is coupled to hitch 106. Wheels 96 are riding on the earth.

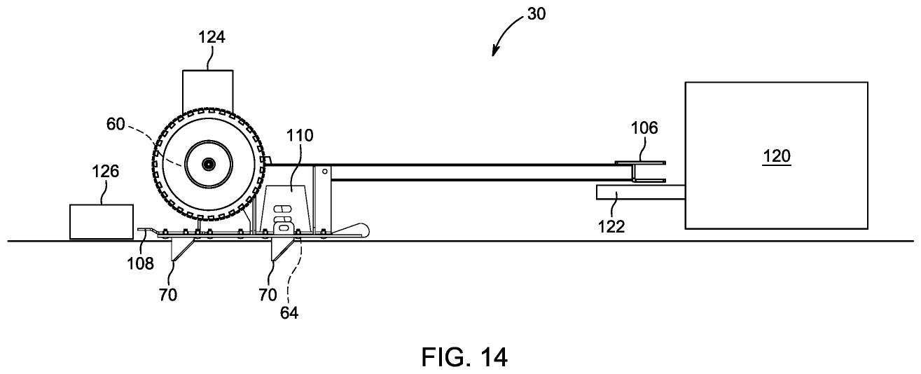

Referring to FIG. 14, tiling implement 30 is shown being towed behind vehicle 120 in a tilling configuration. Hitch 122 is coupled to hitch 106. Blades 70 extend into the earth. Accessory weight 110 is positioned on open region 64. Accessory 124 is coupled to accessory mount 60. Accessory 126 is coupled to accessory mount 108.

The size and weight of tilling implement 30 is such that a single operator can flip tilling implement 30 between blades down and blades up using tongue 104 and rotating tilling implement 30 with trailing edge 44 on the ground. Tilling implement 30 can be towed behind many powered vehicles including all-terrain vehicles, quad bikes, utility vehicles such as side-by-side vehicles, also known as utility task vehicles, sports utility trucks, trucks and the like. Tilling implement 30 is generally no wider than such vehicles, so it can generally be towed through narrower paths and rougher terrain than other tilling devices. However, tilling implement 30 is sufficiently wide that a significant area can be efficiently tilled.

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

We claim:

1. An off-road tilling implement for use with an off-road vehicle, the off-road tilling implement comprising:
a base plate comprising a rounded leading edge;
a plurality of blades extending away from a first side of the base plate, each blade extending at least 4 inches away from the base plate and each blade comprising a cutting edge that is at least 4 inches long;
a wheel assembly extending away from a second side of the base plate, opposite the first side; and
a hitch assembly extending away from the second side of the base plate, wherein the hit assembly comprises a bidirectional hitch adapted to be coupled to the vehicle with either the first side oriented upwardly or the second side oriented upwardly, wherein the tilling implement is adapted to be towed behind the vehicle with the first side oriented upwardly and wherein the tilling implement is adapted to be towed behind the vehicle with the second side oriented upwardly and the plurality of blades extending into the earth to plow the earth.

2. The off-road tilling implement of claim 1, wherein the base plate comprises sheet steel.

3. The off-road tilling implement of claim 1, wherein the base plate is approximately 4 feet wide and 2 feet long.

4. The off-road tilling implement of claim 2, wherein the base plate further comprises a length of pipe welded on the leading edge of the base plate.

5. The off-road tilling implement of claim 1, wherein the plurality of blades are arranged in two rows of blades that extend across a width of the base plate.

6. The off-road tilling implement of claim 5, wherein the plurality of blades are horizontally offset from each other such that each blade occupies a distinct horizontal position on the base plate.

7. The off-road tilling implement of claim 6, wherein the plurality of blades are horizontally spaced at least 4 inches apart from each other.

8. The off-road tilling implement of claim 5, wherein individual blades are spaced at least 8 inches apart from any other individual blade.

9. The off-road tilling implement of claim 5, wherein the plurality of blades are horizontally spaced no more than 7 inches apart from each other.

10. The off-road tilling implement of claim 1, wherein the plurality of blades are removably coupled to the base plate.

11. The off-road tilling implement of claim 10, further comprising a plurality of threaded fasteners that removably couple the plurality of blades to the base plate.

12. The off-road tilling implement of claim 1, wherein the base plate defines a plurality of slots and each of the plurality of blades extends through individual slots of the plurality of slots such that a portion of each of the plurality of blades are positioned on the second side of the base plate.

13. The off-road tilling implement of claim 12, wherein the plurality of blades are removably coupled to the base plate on the second side of the base plate.

14. The off-road tilling implement of claim 13, wherein each of the plurality of blades further comprises a mounting plate.

15. The off-road tilling implement of claim 1, further comprising a first accessory mount on the second side of the base plate.

16. The off-road tilling implement of claim 1, further comprising a second accessory mount on the hitch assembly.

17. The off-road tilling implement of claim 1, wherein the wheel assembly comprises an axle, a first wheel and a second wheel.

18. The off-road tilling implement of claim 1, wherein no part of the wheel assembly is positioned on the first side of the base plate.

19. The off-road tilling implement of claim 1, further comprising a plurality of tie down mounts on the second side of the base plate.

20. The off-road tilling implement of claim 1, wherein the second side of the base plate is adapted to carry a plurality of accessory weights.
